(19) United States
(12) Patent Application Publication
(10) Pub. No.: US 2023/0382188 A1
(43) Pub. Date: Nov. 30, 2023

(54) HEATER ELEMENT FOR HEATING VEHICLE INTERIOR, HEATER UNIT FOR HEATING VEHICLE INTERIOR, AND HEATER SYSTEM FOR HEATING VEHICLE INTERIOR

(71) Applicant: NGK INSULATORS, LTD., Nagoya-City (JP)

(72) Inventors: Yukio MIYAIRI, Nagoya-Shi (JP); Masaaki MASUDA, Nagoya-City (JP); Hirofumi YAMAGUCHI, Nagoya-Shi (JP); Toru HAYASE, Nagoya-Shi (JP); Hiroyuki NAGAOKA, Nagoya-Shi (JP)

(73) Assignee: NGK INSULATORS, LTD., Nagoya-City (JP)

(21) Appl. No.: 18/307,880

(22) Filed: Apr. 27, 2023

Related U.S. Application Data
(63) Continuation of application No. PCT/JP2021/035411, filed on Sep. 27, 2021.

(30) Foreign Application Priority Data
Oct. 27, 2020 (JP) 2020-179951

(51) Int. Cl. B60H 1/22; H05B 3/03

(52) U.S. Cl. CPC B60H 1/2215; H05B 3/03; H05B 2203/02; H05B 2203/024; H05B 2203/023; B60H 2001/00128

(57) ABSTRACT

A heater element for heating a vehicle interior includes: a honeycomb structure comprising: an outer peripheral wall; and a partition wall disposed on an inner side of the outer peripheral wall, the partition wall defining a plurality of cells each forming a flow path from a first end face to a second end face, the outer peripheral wall and the partition wall comprising a material having a PTC property; and a pair of electrodes provided on the first end face and the second end face. Each of the first end face and the second end face of the honeycomb structure is rectangular. The heater element for heating the vehicle interior further includes a pair of connectors, each of the connectors being connected to the electrode from one short side of each of the first end face and the second end face.

### CROSS REFERENCE TO RELATED APPLICATIONS

The present invention claims the benefit of priorities to Japanese Patent Application No 2020-179951 filed on Oct. 27, 2020 and PCT Patent Application No. PCT/JP2021/035411 filed on Sep. 27, 2021, the entire contents of which are incorporated herein by reference in its entirety.

### FIELD OF THE INVENTION

The present invention relates to a heater element for heating a vehicle interior, a heater unit for heating a vehicle interior, and a heater system for heating a vehicle interior.

### BACKGROUND OF THE INVENTION

In recent years, a heater system has been used as a heater system for heating a vehicle interior of an electric vehicle. The heater system uses a vapor compression heat pump as a main heater, while supplementarily using a heater utilizing Joule heat when rapid heating is required at the start of the vehicle or when the outside temperature is extremely low.

As the heater utilizing Joule heat used in the heater system, Patent Literature 1 proposes a heater unit in which heater elements having PTC elements integrated with aluminum fins are stacked and arranged.

However, the heater element includes many parts such as insulating plates and conductive plates in addition to the PTC elements and the aluminum fins. Therefore, the heater element has problems that it has a complicated structure and is expensive due to high assembly costs.

Therefore, Patent Literature 2 proposes a heater element using a honeycomb structure that is compact and capable of increasing a heat transfer area per unit volume. The heater element using the honeycomb structure has an advantage of having a simpler structure than that of the heater element as described above.

### PRIOR ART

### Patent Literature

### [PTL 1]

Japanese Patent Application Publication No. 2007-157528 A

### [PTL 2]

WO 2020/036067 A1

### SUMMARY OF THE INVENTION

The present invention relates to a heater element for heating a vehicle interior, comprising:

a honeycomb structure comprising: an outer peripheral wall; and a partition wall disposed on an inner side of the outer peripheral wall, the partition wall defining a plurality of cells each forming a flow path from a first end face to a second end face, the outer peripheral wall and the partition wall comprising a material having a PTC property; and

a pair of electrodes provided on the first end face and the second end face,

wherein each of the first end face and the second end face of the honeycomb structure is rectangular, and

wherein the heater element for heating the vehicle interior further comprises a pair of connectors, each of the connectors being connected to the electrode from one short side of each of the first end face and the second end face.

The present invention also relates to a heater unit for heating a vehicle interior, comprising two or more of the heater elements for heating the vehicle interior,

wherein the heater elements for heating the vehicle interior are stacked and arranged such that surfaces of the outer peripheral walls of the honeycomb structures, including long sides of the first end faces and the second end faces, are opposed to each other.

The present invention also relates to a heater system for heating a vehicle interior, comprising:

the heater unit for heating the vehicle interior;

an inflow pipe for communicating an outside air introduction portion or a vehicle interior with an inflow port of the heater unit for heating the vehicle interior;

a battery for applying a voltage to the heater unit for heating the vehicle interior; and

an outflow pipe for communicating an outflow port of the heater unit for heating the vehicle interior with the vehicle interior.

### BRIEF DESCRIPTION OF THE DRAWINGS

FIG. 1 is a schematic perspective view of a heater element according to an embodiment of the present invention.

FIG. 2 is a schematic side view of a heater element as viewed from the direction A in FIG. 1.

FIG. 3 is a schematic perspective view of a honeycomb structure forming the heater element of FIG. 1.

FIG. 4 is a schematic end view of a honeycomb joined body having five honeycomb segments.

FIG. 5 is a schematic front view of a heater unit according to an embodiment of the present invention as viewed from a first end face side of a heater element.

FIG. 6 is a schematic view showing a configuration example of a heater system according to an embodiment of the present invention.

FIG. 7 is a schematic plane view of a heater element prepared in Comparative Example.

FIG. 8 is a graph comparing results of electrical conduction tests according to Example 1 and Comparative Example 1.

FIG. 9 is a graph comparing results of electrical conduction tests according to Examples 1 and 2.

### DETAILED DESCRIPTION OF THE INVENTION

The present inventors have found that when the heater element described in Patent Literature 2 is used for an existing heater unit, it is necessary to change designs of parts such as wirings and holders of the existing heater unit. This results in a larger heater unit, which will lose the advantage of the compact heater element. Therefore, there is a need for improvement.

The present invention has been made to solve the above problems. An object of the present invention is to provide a heater element for heating a vehicle interior, which has a simpler structure than that of the existing heater element, and which can suppress an increase in the size of the heater unit due to design changes of parts such as wirings and holders of the existing heater unit. Another object of the present invention is to provide a heater unit for heating a vehicle interior and a heater system for heating a vehicle interior, which use the heater element for heating the vehicle interior.

According to the present invention, it is possible to provide a heater element for heating a vehicle interior, which has a simpler structure than that of the existing heater element, and which can suppress an increase in the size of the unit due to design changes of parts such as wirings and holders of the existing heater unit. Also, according to the present invention, it is possible to provide a heater unit for heating a vehicle interior and a heater system for heating a vehicle interior, which use the heater element for heating the vehicle interior.

Hereinafter, embodiments of the present invention will be specifically described with reference to the drawings. It is to understand that the present invention is not limited to the following embodiments, and those which have appropriately added changes, improvements and the like to the following embodiments based on knowledge of a person skilled in the art without departing from the spirit of the present invention fall within the scope of the present invention.

### (1. Heater Element)

A heater element according to an embodiment of the present invention can be suitably utilized as a heater element for heating a vehicle interior of a vehicle. The vehicle includes, but not limited to, automobiles and electric railcars. Non-limiting examples of the automobile include a gasoline vehicle, a diesel vehicle, a gas fuel vehicle using CNG (a compressed natural gas) or LNG (a liquefied natural gas), a fuel cell vehicle, an electric vehicle, and a plug-in hybrid vehicle. The heater element according to the embodiment of the present invention can be particularly suitably used for a vehicle having no internal combustion engine such as electric vehicles and electric railcars.

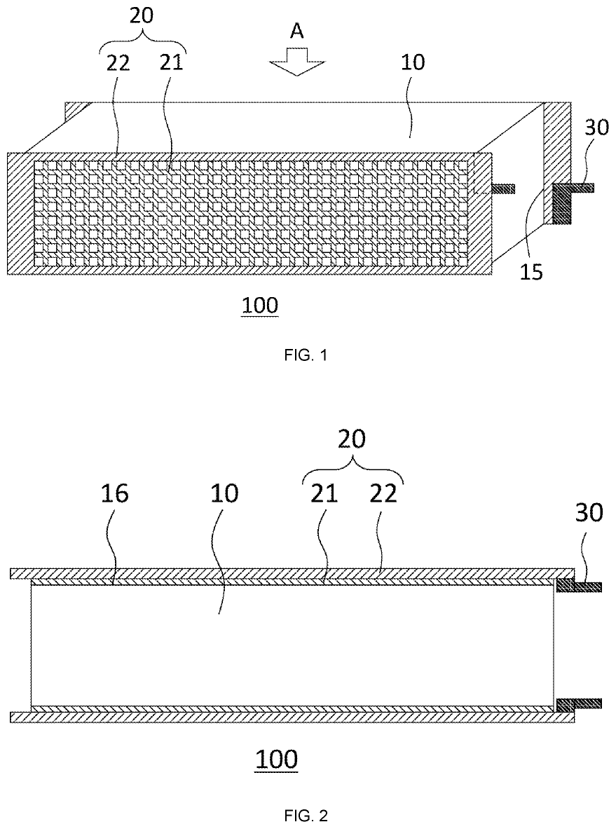

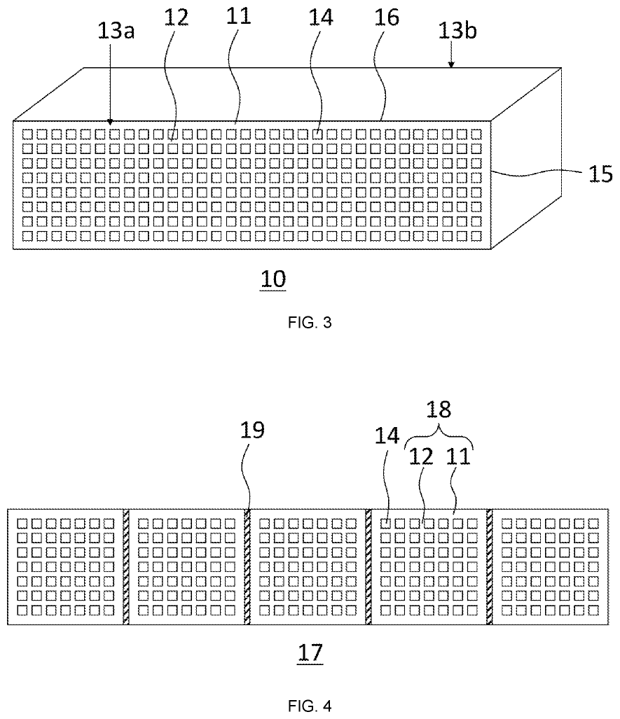

FIG. 1 is a schematic perspective view of a heater element according to an embodiment of the present invention. FIG. 2 is a schematic side view of a heater element as viewed from the direction A in FIG. 1. FIG. 3 is a schematic perspective view of a honeycomb structure forming the heater element of FIG. 1.

A heater element 100 includes: a honeycomb structure 10 having: an outer peripheral wall 11; and a partition wall 12 disposed on an inner side of the outer peripheral wall 11, the partition wall 11 defining a plurality of cells 14 each forming a flow path from a first end face 13a to a second end face 13b; and a pair of electrodes 20 provided on the first end face 13a and the second end face 13b. Each of the end faces (the first end face 13a and the second end face 13b) is rectangular. Also, the heater element 100 further includes a pair of connectors 30, and each of the connectors 30 is connected to the electrode 20 from one short side 15 side of each of the first end face 13a and the second end face 13b. Thus, each end face of the honeycomb structure 10 is rectangular, and the heater element has the pair of connectors 30 connected to the end faces of the honeycomb structure 10 as described above, so that the size of heater unit can be prevented from being increased due to design changes of parts such as wirings and holders of the existing heater unit to make the heater unit compact.

### (1-1. Honeycomb Structure 10)

The honeycomb structure 10 has the end faces (first end face 13a and second end face 13b), which are rectangular. That is, each end face of the honeycomb structure 10 has a rectangular shape having short sides 15 and long sides 16.

A ratio of the length of the short side 15 to the length of the long side 16 is preferably 1:2 to 1:10, and more preferably 1:3 to 1:8, although not particularly limited thereto. The control of the ratio to such a range allows the size of the honeycomb structure to be matched to the size of the heater element used in existing heater unit.

The shape of each cell 14 in the cross section orthogonal to the flow path direction of the cells 14 is not limited, but it may preferably be a quadrangle (rectangle, square), a hexagon, an octagon, or a combination thereof. Among these, the quadrangle and hexagon are preferable. By forming the cells 14 into such a shape, it is possible to reduce the pressure loss when a gas passes through the honeycomb structure 10. The honeycomb structure 10 in the heater element shown in FIG. 1 is an example where the shape of each cell 14 in the cross section orthogonal to the flow path direction of the cells 14 is square.

The honeycomb structure 10 may be a honeycomb joined body having a plurality of honeycomb segments and joining layers for joining the plurality of honeycomb segments to each other. The use of the honeycomb joined body can lead to an increase in the total cross-sectional area of the cells 14, which is important for ensuring a gas flow rate, while suppressing the generation of cracks.

Here, as an example, FIG. 4 shows a schematic end view of a honeycomb joined body having five honeycomb segments.

As shown in FIG. 4, the honeycomb joined body 17 has the five honeycomb segments 18 and the joining layers 19 for joining the honeycomb segments 18 to each other. Each honeycomb segment 18 has the outer peripheral wall 11 and the partition wall 12 disposed on the inner side of the outer peripheral wall 11 and defining the plurality of cells 14 each forming a flow path from the first end face 13a to the second end face 13b.

Each joining layer 19 can be formed by using a joining material. The joining material is not particularly limited, but a ceramic material obtained by adding a solvent such as water to form a paste can be used. The joining material may contain ceramics having a PTC property, or may contain the same ceramics as the outer peripheral wall 11 and the partition wall 12. In addition to the role of joining the honeycomb segments 18 to each other, the joining material can also be used as an outer peripheral coating material after joining the honeycomb segments 18.

From the viewpoint of ensuring the gas flow rate, the area of each end face of the honeycomb structure 10 is preferably 20 cm² or more, and more preferably 50 cm² or more, and even more preferably 70 cm² or more. From the viewpoint of making the heater element 100 compact, the area of each end face of the honeycomb structure 10 is preferably 500 cm² or less, and more preferably 300 cm² or less, and still more preferably 200 cm² or less. The area of each end face of the honeycomb structure 10 can be, for example, 20 to 500 cm².

From the viewpoint of making the heater element 100 compact, the length of the honeycomb structure 10 (flow path length of each cell 14) is preferably 40 mm or less, and more preferably 30 mm or less, and still more preferably 20 mm or less, and even more preferably 10 mm or less. From the viewpoint of ensuring heating performance and strength, the length of the honeycomb structure 10 (flow path length of each cell 14) is preferably 3 mm or more. The length of the honeycomb structure 10 (flow path length of each cell 14) can be, for example, 3 to 40 mm.

### (1-1-1. Material of Honeycomb Structure 10)

The outer peripheral wall 11 and the partition wall 12 of the honeycomb structure 10 are formed of a material that can generate heat by electrical conduction. Therefore, a gas such as outside air or vehicle interior air can be heated by heat transfer from the heating outer peripheral wall 11 and partition wall 12 while the gas flows in the first end face 13a, passes through the plurality of cells 14, and flows out from the second end face 13b.

Further, the outer peripheral wall 11 and the partition wall 12 are composed of a material having a PTC (Positive Temperature Coefficient) property. That is, the outer peripheral wall 11 and the partition wall 12 have a property that, as the temperature is increased to exceed the Curie point, a resistance value is rapidly increased, resulting in difficulty for electricity to flow. Since the outer peripheral wall 11 and the partition wall 12 have the PTC property, the current flowing through them is limited when the heater element 100 becomes hot, so that excessive heat generation of the heater element 100 is prevented.

From the viewpoint of being able to generate heat upon the electrical conduction and of having the PTC property, the outer peripheral wall 11 and the partition wall 12 are preferably formed of ceramics made of a material containing barium titanate as a main component, and more preferably ceramics made of a material containing 70% by mass of barium titanate, and even more preferably ceramics made of a material containing 90% by mass or more of barium titanate. As used herein, the term “main component” means a component in which a proportion of the component in the total component is more than 50% by mass. The content of barium titanate can be determined by, for example, fluorescent X-ray analysis, EDAX (energy dispersive X-ray) analysis, or the like.

It is preferable that the ceramics contains one or more additives such as rare earth elements in order to obtain a desired PTC property. The additives include semiconductor agents such as Y, La, Ce, Pr, Nd, Sm, Eu, Gd, Tb, Dy, Ho, Er, Tm, Yb, Sc and Lu; low temperature side shifters such as Sr, Sn and Zr; high temperature side shifters such as (Bi—Na), and (Bi—K); property improving agents such as Mn; metal oxides such as vanadium oxide and ytterbium oxide (in particular oxides of rare earth elements); and conductor powders such as carbon black and nickel. Other PTC materials include composite materials containing cristobalite phase SiO₂ as a base material and a conductive filler. As a substitute for the cristobalite phase SiO₂ base material, tridymite phase SiO₂, cristobalite phase AlPO₄, and tridymite phase AlPO₄ can also be used.

Further, from the viewpoint of the environmental impact of waste, the outer peripheral wall 11 and the partition wall 12 are preferably formed of ceramics made of a material that is substantially free of lead, and more preferably ceramics made of a material having a lead content of 0.001% by mass or less. As used herein, the term “substantially free” means that a ratio of the component to the total component is 0.01% by mass or less. The lead content can be determined by, for example, fluorescent X-ray analysis, ICP-MS (inductively coupled plasma mass spectrometry), or the like.

The material making up the outer peripheral wall 11 and the partition wall 12 preferably has a Curie point of 100° C. or more, and more preferably 110° C. or more, and even more preferably 125° C. or more, in terms of efficiently heating the air for heating. Further, the upper limit of the Curie point is preferably 250° C. or less, and preferably 225° C. or less, and even more preferably 200° C. or less, and still more preferably 150° C. or less, in terms of safety as a component placed in the vehicle interior or near the vehicle interior.

The Curie point of the material making up the outer peripheral wall 11 and the partition wall 12 can be adjusted by the type of shifter and an amount of the shifter added. For example, the Curie point of barium titanate (BaTlO₃) is about 120° C., but the Curie point can be shifted to the lower temperature side by substituting a part of Ba and Ti with one or more of Sr, Sn and Zr.

In the present invention, the Curie point is measured by the following method. A sample is attached to a sample holder for measurement, mounted in a measuring tank (e.g., MINI-SUBZERO MC-810P, from TABAI ESPEC), and a change in electrical resistance of the sample as a function of a temperature change when the temperature is increased from 10° C. is measured using a DC resistance meter (e.g., Multimeter 3478A, from YHP). Based on an electrical resistance-temperature plot obtained by the measurement, a temperature at which the resistance value is twice the resistance value at room temperature (20° C.) is defined as the Curie point.

### (1-1-2. Thickness of Partition Wall 12 of Honeycomb Structure 10)

From the viewpoint of suppressing the initial current, it is advantageous to reduce the current path and increase the electrical resistance. Therefore, the thickness of the partition wall 12 in the honeycomb structure is preferably 0.125 mm or less, and more preferably 0.075 mm or less. However, from the viewpoint of ensuring the strength of the honeycomb structure 10, the thickness of the partition wall 12 is preferably 0.020 mm or more, and more preferably 0.040 mm or more, and even more preferably 0.060 mm or more. The thickness of the partition wall 12 refers to a length of a line segment that crosses the partition wall 12 when connecting the centers of gravity of adjacent cells 14 in a cross section orthogonal to the flow path direction of the cell 14. The thickness of the partition wall 12 refers to an average thickness of the entire partition wall 12.

From the viewpoint of reinforcing the honeycomb structure 10, the thickness of the outer peripheral wall 11 is preferably 0.05 mm or more, and more preferably 0.06 mm or more, and even more preferably 0.08 mm or more. However, the thickness of the outer peripheral wall 11 is preferably 1.0 mm or less, and more preferably 0.5 mm or less, and even more preferably 0.4 mm or less, and still more preferably 0.3 mm or less, from the viewpoints of increasing the electrical resistance, suppressing the initial current, and reducing the pressure loss when the gas passes through. The thickness of the outer peripheral wall 11 refers to a length from a boundary between the outer peripheral wall 11 and the outermost cell 14 or the partition wall 12 to a side surface of the honeycomb structure in the normal direction of the side surface in the cross section orthogonal to the flow path of the cells 14.

### (1-1-3. Cell Density and Cell Pitch of Honeycomb Structure 10)

The cell density of the honeycomb structure 10 is preferably 93 cells/cm² or less, and more preferably 62 cells/cm² or less. Moreover, the cell pitch of the honeycomb structure 10 is preferably 1.0 mm or more, and more preferably 1.3 mm or more. By controlling the cell density or cell pitch to such a range, the air passing resistance can be suppressed and an output of a blower can be suppressed.

Although the lower limit of the cell density of the honeycomb structure 10 is not particularly limited, it may preferably be 10 cells/cm² or more, and more preferably 20 cells/cm² or more. The upper limit of the cell pitch of the honeycomb structure 10 is also not particularly limited, but it may preferably be 3.0 mm or less, and more preferably 2.0 mm or less. The cell density of the honeycomb structure 10 is a value obtained by dividing the number of cells by the area of each end face of the honeycomb structure 10. Further, the cell pitch of the honeycomb structure 10 refers to a length of a line segment connecting the centers of gravity of two adjacent cells 14 on each end face of the honeycomb structure 10.

### (1-2. Electrode 20)

The heater element 100 according to an embodiment of the present invention has a pair of electrodes 20 on the first end face 13a and the second end face 13b. By applying a voltage through the pair of electrodes 20, a current can be conducted through the honeycomb structure 10 to generate heat by Joule heat.

Each electrode 20 preferably has an extending portion extending outwardly in the same direction from one short side 15 side of each of the first end face 13a and the second end face 13b, and the extending portion is preferably connected to the connector, although not particularly limited thereto. The provision of the extending portions facilitates connection to the connectors 30.

The electrodes 20 may be composed of a single member, or may be composed of a plurality of members.

When the electrodes 20 are composed of a single member, for example, the electrodes 20 can be electrode layers 21 provided on the first end face 13a and the second end face 13b. In this case, the electrode layers 21 are provided on the surfaces of the outer peripheral wall 11 and the partition wall 12 on the first end face 13a and the second end face 13b, and have extending portions each extending outwardly from one short side 15 side of each of the first end face 13a and the second end face 13b in the same direction.

When the electrodes 20 are composed of the plurality of members, for example, as shown in FIGS. 1 and 2, the electrodes 20 can include the electrode layers 21 provided on the first end face 13a and the second end face 13b, and electrode plates 22 provided on the electrode layers 21. In this case, the electrode layers 21 are provided on the surfaces of the outer peripheral wall 11 and the partition wall 12 on the first end face 13a and the second end face 13b, and the electrode plates 22 are provided on the outer peripheral wall 11 on which the electrode layers 21 are provided, via the electrode layers 21. Each electrode plate 22 has an opening so as not to block portions (the surface of the partition wall 12 provided with the electrode layer 21 and the cells 14) other than the outer peripheral wall 11 provided with the electrode layer 21. Further, each electrode plate 22 has the extending portion extending outwardly in the same direction from one short side 15 side of each of the first end face 13a and the second end face 13b.

A method for connecting the electrode layer 21 to the electrode plate 22 may employ diffusion bonding, mechanical pressure mechanism, welding, and the like, although not particularly limited thereto.

A carbon sheet may be provided between the electrode layer 21 and the electrode plate 22 as needed, in terms of improving the contact between both.

The electrode layer 21 that can be used herein includes, but not particularly limited to, a metal or alloy containing at least one selected from Cu, Ag, Al, Ni and Si. It is also possible to use an ohmic electrode layer capable of ohmic contact with the outer peripheral wall 11 and/or the partition wall 12, which has a PTC property. The ohmic electrode layer contains, for example, at least one selected from Au, Ag and In as a base metal, and contains at least one selected from Ni, Si, Ge, Sn, Se and Te for n-type semiconductors as a dopant. Further, the electrode layer 21 may have one layer or two or more layers. When the electrode layer 21 has two or more layers, materials of the respective layers may be of the same type or different types.

Although the electrode plate 22 is not particularly limited, it is plate-shaped and can be made of a highly conductive material. The electrode plate 22 can be, for example, a metal plate such as a copper plate or a stainless steel plate.

### (1-3. Connector 30)

The heater element 100 according to an embodiment of the present invention includes a pair of connectors 30 connected to the electrodes 20 from one of the short sides 15 of the first end face 13a and the second end face 13b of the honeycomb structure 10. Each connector 30 is a terminal that can be electrically connected to a power supply. By providing the pair of connectors 30 at such positions, it can be used in place of the existing heater element, and it can suppress an increase in the size of the heater unit due to design changes of parts such as wirings of the existing heater unit.

Each connector 30 is preferably connected to the surface of the extending portion of the electrode 20 on the honeycomb structure 10 side. Such a configuration allows the heater element 100 to be made compact, so that it can be easily applied to the existing heater units.

A method for connecting the electrode 20 to the connector 30 is not particularly limited as long as they are electrically connected to each other. For example, they can be connected by diffusion bonding, a mechanical pressure mechanism, welding, or the like.

The connector 30 may be made of, for example, a metal, although not limited thereto. The metal that can be used herein includes a single metal, an alloy, and the like. In terms of corrosion resistance, electrical resistance, and linear expansion rate, for example, the metal may preferably be an alloy containing at least one selected from the group consisting of Cr, Fe, Co, Ni, Cu, and Ti, and more preferably stainless steel, Fe—Ni alloys, and phosphorus bronze.

The shape and size of the connector 30 are not particularly limited, but they may be appropriately adjusted according to the structure of the existing heater unit.

### (1-4. Method for Producing Heater Element 100)

Next, a method for producing the heater element 100 according to an embodiment of the present invention will be illustratively described. First, a raw material composition containing a dispersion medium and a binder is mixed with a ceramic raw material and kneaded to prepare a green body, which is then extruded to prepare a honeycomb formed body. To the raw material composition may optionally be added additives such as dispersants, plasticizers, semiconductor agents, shifters, metal oxides, property improving agents, and conductor powder. In the extrusion, a die having a desired overall shape, cell shape, partition wall thickness, cell density and the like can be used.

The ceramic raw material can be provided, for example, in the form of powder. The ceramic raw material that can be used herein include oxides such as TlO₂ and BaCO₃ which are main components of barium titanate, and carbonate raw materials. Also, as the semiconductor agent such as Y, La, Ce, Pr, Nd, Sm, Eu, Gd, Tb, Dy, Ho, Er, Tm, Yb, Sc and Lu, the low temperature side shifter such as Sr, Sn and Zr, the high temperature side shifter such as (Bi—Na), (Bi—K), and the property improving agent such as Mn, oxides and/or carbonates of these, or oxalates that will form oxides after firing, may be used. Conductor powder such as carbon black and nickel may be added to control conductivity. The addition of the alkali metal element of Na or K can also be used in the form of a binder containing the alkali metal element.

Further, for example, after adding La (NO₃)₃·6H₂O to the raw material powder such as TiO₂ and BaCO₃, a dispersant and a binder can be further added, and blended so as to have BaO (50.3 mol %), TiO₂ (49.6 mol %), La₂O₃ (0.05 mol %), K₂O (0.033 mol %), and Na₂O (0.002 mol %) as a fired body, thereby providing the honeycomb structure containing substantially no lead (i.e., free of lead). However, it is not limited to the composition, and the blending can be carried out so as to have 90% by mass or more of ceramics having a compositional formula represented by the following formula, thereby providing a honeycomb structure which contains rare earth elements and alkali metal elements and does not use lead:

(Ba_{1-x-y}A1ₓA2_{y})TiO₃

In the formula, A1 represents one or more rare earth elements, A2 represents one or more alkali metal elements, 0.001≤x≤0.01, 0.001≤y≤0.01, 0.002≤x+y≤0.02.

Examples of the dispersion medium include water or a mixed solvent of water and an organic solvent such as alcohol, and more preferably water.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose in combination with hydroxypropoxyl cellulose. Further, the binder content is preferably from 4 to 9 parts by mass, based on 100 parts by mass of the ceramic raw material, in terms of increasing the strength of the honeycomb formed body and of suppressing the generation of tearing due to abnormal heat generation in the firing step. The binder may be used alone, or in combination of two or more.

The dispersant that can be used herein includes surfactants such as ethylene glycol, dextrin, fatty acid soaps, polyalcohol and organophosphorus compounds. The dispersant may be used alone or in combination of two or more. The content of the dispersant is preferably 0 to 2 parts by mass based on 100 parts by mass of the ceramic raw material.

The resulting honeycomb formed body is then dried. The drying step may employ, for example, a conventionally known drying method such as hot air drying, microwave drying, dielectric drying, drying under reduced pressure, drying in vacuum, and freeze drying. Among these, a drying method that combines the hot air drying with the microwave drying or dielectric drying is preferable.

The dried honeycomb formed body can be then fired to produce a pillar shaped honeycomb structure. Prior to the firing, a degreasing step may be carried out to remove the binder. For example, when the material of the honeycomb formed body contains barium titanate as a main component, the firing temperature is preferably 1100 to 1400° C. The firing time is preferably about 1 to 4 hours.

An atmosphere for carrying out the degreasing step can be, for example, an air atmosphere, an inert atmosphere, or a reduced pressure atmosphere. Among these, the inert atmosphere and the reduced pressure atmosphere are preferable. The firing furnace is not particularly limited, but an electric furnace, a gas furnace, or the like can be used.

The electrodes 20 are formed on the first end face 13a and the second end face 13b of the honeycomb structure thus obtained. For example, the electrode layers 21 on the electrodes 20 can be formed by a metal deposition method such as sputtering, vapor deposition, electrolytic deposition, and chemical deposition. Further, the electrode layers 21 can also be formed by applying an electrode paste and then baking the electrode paste. Further, the electrode layers 21 can also be formed by thermal spraying. The electrode layer 21 may be a single layer, but may be a plurality of layers having different compositions. When the electrode layer 21 is formed by the above method, the cells 14 can be prevented from being blocked by setting the thickness of the electrode layer 21 so as not to be excessively large. For example, it is preferable that the thickness of each electrode layer 21 is from about 5 to 30 μm for baking of the electrode paste, from about 100 to 1000 nm for dry plating such as sputtering and vapor deposition, from about 10 to 100 μm for thermal spraying, or from about 5 to 30 μm for wet plating such as electrolytic deposition and chemical deposition.

When the electrode plate 22 is provided on the electrode layer 21, the electrode plate 22 is placed on the electrode layer 21 and connected to each other. A method for connecting the electrode layer 21 to the electrode plate 22 can employ the method as described above.

The connectors 30 are then connected to the electrodes 20. A method for connecting the electrodes 20 to the connectors 30 can employ the method as described above.

### (1-5. Method for Using Heater Element 100)

The heater element 100 according to the embodiment of the present invention can generate heat by applying a voltage via the pair of electrodes 20 from the connectors 30, for example. For the applied voltage, it is preferable to apply a voltage of 200 V or more, and it is more preferable to apply a voltage of 250 V or more, from the viewpoint of rapid heating.

When the heater element 100 generates heat due to the application of the voltage, the gas can be heated by allowing the gas to flow through the cells 14. A temperature of the gas flowing into the cells 14 can be, for example, −60° C. to 20° C., and typically −10° C. to 20° C.

The heater element 100 according to the embodiment of the present invention has a simpler structure than that of the existing heater element in which PTC elements and aluminum fins are integrated, and can prevent the heater unit from becoming larger due to design changes of parts such as wirings and holders. Further, in the existing heater element, the PTC element is not in direct contact with the gas, resulting in an insufficient heating rate (heating time) of the gas, whereas in the heater element 100 according to the embodiment of the present invention, the honeycomb structure 10 in which the outer peripheral wall 11 and the partition wall 12 are made of the material having the PTC property is in direct contact with the gas, resulting in an increased heating rate of the gas. Further, the heater element 100 according to the embodiment of the present invention has a less amount of power consumption than that of the existing heater element.

### (2. Heater Unit)

The heater unit according to an embodiment of the present invention can be suitably used as a heater unit for heating a vehicle interior of a vehicle. In particular, the heater unit according to the embodiment of the present invention can suppress an increase in the size of the heater unit due to design changes of parts such as wirings and holders of the existing heater unit. Therefore, the heater element 100 as described above can be used in place of the existing heater element.

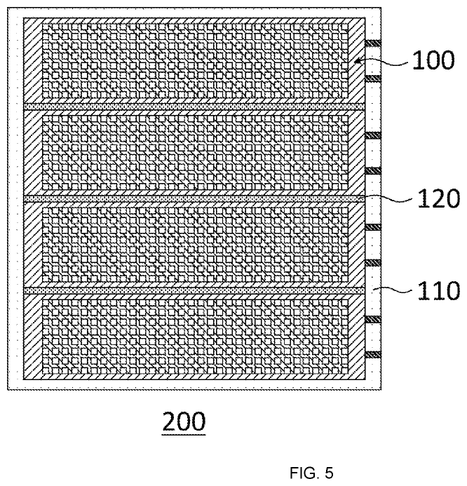

FIG. 5 is a schematic front view of a heater unit according to an embodiment of the present invention as viewed from the first end face side of the heater element.

As shown in FIG. 5, a heater unit 200 according to an embodiment of the present invention includes two or more heater elements 100. Further, in the heater unit 200, the heater elements 100 are stacked and arranged so that the surfaces of the outer peripheral walls 11 of the honeycomb structures 10 including the long sides of the first end faces 13a and the second end faces 13b face each other. Such a configuration can produce the heater unit 200 without significantly changing the designs of parts such as wirings and holders.

The heater unit 200 according to the embodiment of the present invention may further include a housing (housing member) 110.

The housing 110 may be made of any material, including, but not limited to, for example, metals and resins. Among them, the material of the housing 110 is preferably the resin. The housing 110 made of the resin can suppress electric shock without grounding.

The shape and size of the housing 110 are not particularly limited, but they may be the same as those of the existing heater unit.

The heater unit 200 according to the embodiment of the present invention may further include insulating materials 120 each arranged between the heater elements 100 which are stacked. Such a configuration can suppress an electrical short circuit between the plurality of heater elements 100.

The insulating materials 120 that can be used herein include plate materials, mats, clothes, and the like, which are formed of an insulating material such as alumina or ceramics.

### (3. Heater System)

The heater system according to an embodiment of the present invention can be suitably used as a heater system for heating a vehicle interior of a vehicle. In particular, the heater system according to the embodiment of the present invention can suppress an increase in the size of the heater unit due to design changes of parts such as wirings and holders of the existing heater unit.

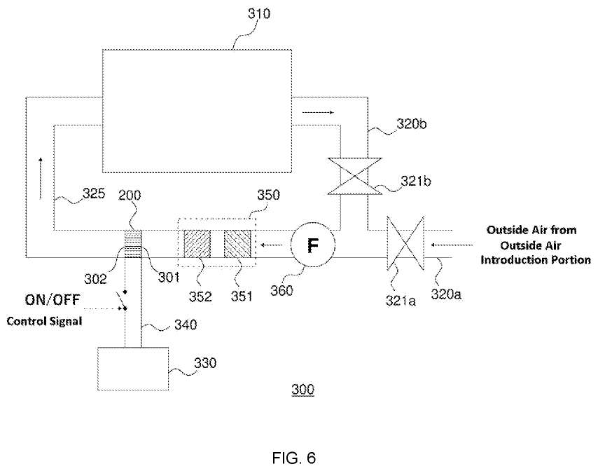

FIG. 6 is a schematic view showing a configuration example of a heater system according to an embodiment of the present invention.

As shown in FIG. 6, a heater system 300 according to the embodiment of the present invention includes: the heater unit 200 according to the embodiment of the present invention; inflow pipes 320a, 320b for communicating an outside air introduction portion or a vehicle interior 310 with an inflow port 301 of the heater unit 200; a battery 330 for applying a voltage to the heater unit 200; and an outflow pipe 325 for communicating an outflow port 302 of the heater unit 200 with the vehicle interior 310.

The heater unit 200 can be configured to apply a current to the heater unit 200 to generate heat by connecting to the battery 330 with an electric wire 340 and turning on a power switch in the middle of the wiring, for example.

Disposed on the upstream side of the heater unit 200 can be a vapor compression heat pump 350. In the heater system 300, the vapor compression heat pump 350 is configured as a main heating device, and the heater unit 200 is configured as an auxiliary heater. The vapor compression heat pump 350 can be provided with a heat exchanger including: an evaporator 351 that functions to absorb heat from the outside during cooling to evaporate a refrigerant; and a condenser 352 that functions to liquefy a refrigerant gas to release heat to the outside during heating. The vapor compression heat pump 350 is not particularly limited, and a vapor compression heat pump known in the art can be used.

On the upstream side and/or the downstream side of the heater unit 200, a blower 360 can be installed. In terms of ensuring safety by arranging high-voltage parts as far as possible from the vehicle interior 310, the blower 360 is preferably installed on the upstream side of the heater unit 200. As the blower 360 is driven, air flows into the heater unit 200 from the inside or outside of the vehicle interior 310 through the inflow pipes 320a, 320b. The air is heated while passing through the heating unit 200 that is generating heat. The heated air flows out from the heater unit 200 and is delivered into the vehicle interior 310 through the outflow pipe 325. The outlet of the outflow pipe 325 may be arranged near the feet of an occupant so that the heating effect is particularly high even in the vehicle interior 310, or a pipe outlet may be arranged in a seat to warm the seat from the inside, or may be arranged near a window to have an effect of suppressing fogging of the window.

The inflow pipe 320a and the inflow pipe 320b merge in the middle. The inflow pipe 320a and the inflow pipe 320b can be provided with valves 321a and 321b, respectively, on the upstream side of the confluence. By controlling the opening and closing of the valves 321a, 321b, it is possible to switch between a mode where the outside air is introduced into the heater unit 200 and a mode where the air in the vehicle interior 310 is introduced into the heater unit 200. For example, the opening of the valve 321a and the closing of the valve 321b results in the mode where the outside air is introduced into the heater unit 200. It is also possible to open both the valve 321a and the valve 321b to introduce the outside air and the air in the vehicle interior 310 into the heater unit 200 at the same time.

### EXAMPLES

Hereinafter, the present invention will be described in more detail with reference to Examples, but the present invention is not limited to these Examples.

### Example 1

A binder, a dispersant, plasticizers, and water were added to a ceramic raw material, mixed, and then kneaded to prepare a green body. As the ceramic raw material, a mixture of BaCO₃ powder, TiO₂ powder and La(NO₃)₃·6H₂O powder was used so as to obtain barium titanate in which 0.1% of La was substituted with Ba after firing. Methyl cellulose was used as the binder, and 6 parts by mass of the binder was mixed with 100 parts by mass of the ceramic raw material. A potassium-containing alkyl phosphate was used as the dispersant, and 0.5 part by mass of the dispersant was added to 100 parts by mass of the ceramic raw material. An ether ester compound and alkanediol were used as the plasticizers, and 0.5 parts by mass of the ether ester compound and 1 part by mass of the alkanediol were added to 100 parts by mass of the ceramic raw material.

The extrusion was carried out so as to obtain a rectangular pillar shaped honeycomb segment which had a thickness of the partition wall of 0.100 mm, a cell density of 62 cells/cm², and a cell pitch of 1.27 mm, and in which a cross section orthogonal to the cell extending direction had a rectangular shape of 30 mm×34 mm and a length in the cell extending direction was 14 mm, after firing, thereby providing a honeycomb formed body.

The honeycomb formed body was then dried, degreased, and fired in an air atmosphere at 1400° C. for 2 hours to obtain a honeycomb segment.

Subsequently, the five honeycomb segments described above were prepared, and a joining material was applied to the side surfaces of the honeycomb segments and joined to each other to obtain a honeycomb joined body as shown in FIG. 4. The honeycomb joined body had a rectangular cross section of 30 mm×175 mm orthogonal to the cell extending direction and a length of 14 mm in the cell extending direction. As the bonding material, a paste made by adding a solvent such as water to a ceramic material was used. The area of the end face of the honeycomb joined body was 52.5 cm².

After applying an Al—Ni electrode paste on the first end face and the second end face of the honeycomb joined body, a silver electrode paste was applied and baked at 700° C. to form the Al—Ni electrode layers and the silver electrode layers.

Carbon sheets and copper electrode plates were then sequentially arranged and joined onto the silver electrode layers formed on the surface of the outer peripheral wall on the outer peripheral side of the honeycomb joined body. As with the structures shown in FIGS. 1 and 2, the copper electrode plate has an opening that did not block portions (the surface of the partition wall on which each electrode layer was provided and the cells) other than the outer peripheral wall on which each electrode layer was provided, and the extending portions were formed to extend outwardly in the same direction from one of the short sides of the first end face and the second end face of the honeycomb joined body. Each carbon sheet was placed between the silver electrode layer and the copper electrode plate.

As with the structures shown in FIGS. 1 and 2, a phosphor bronze connector was connected to the extending portion of each copper electrode plate to obtain a heater element.

Subsequently, as with the structure shown in FIG. 5, the four heater elements were stacked and housed in a housing to obtain a heater unit. An alumina fiber mat (insulating material) was placed between the stacked heater elements.

The above heater unit was incorporated into HVAC (Heating Ventilation and Air Conditioning) of a commercially available vehicle, and the electrical conduction heating test was subjected to the heater unit at a gas flow rate of 6 m/sec while limiting a current to 30 A or less under a constant voltage control of 200 V.

As a result, the gas temperature at the outlet of the HVAC reached 50° C. in 6 seconds after the electrical conduction heating, and increased to 88° C. after 60 seconds. The electric power at this time was 2.8 kW. Also, the energy consumption after 30 seconds of the start of electrical conduction was 90 kJ.

### Example 2

Using the same green body as that of Example 1, the extrusion was carried out so as to obtain a rectangular pillar shaped honeycomb segment which had a thickness of the partition wall of 0.125 mm, a cell density of 62 cells/cm², and a cell pitch of 1.27 mm, and in which a cross section orthogonal to the cell extending direction had a rectangular shape of 30 mm×175 mm and a length in the cell extending direction was 14 mm, after firing, thereby providing a honeycomb formed body.

The honeycomb formed body was then dried, degreased, and fired in an air atmosphere at 1400° C. for 2 hours to obtain a honeycomb structure. The area of the end face of the honeycomb structure was 52.5 cm².

Subsequently, under the same conditions as those of Example 1, Al—Ni electrode layers and silver electrode layers were formed on the first end face and the second end face of the honeycomb structure, and carbon sheets and copper electrode plates were sequentially arranged on the silver electrode layers and joined, and the connectors were connected to the extending portions of the copper electrode plates to obtain a heater element.

Subsequently, under the same conditions as those of Example 1, the four heater elements as described above were stacked and housed in a housing to obtain a heater unit.

The above heater unit was incorporated into HVAC (Heating Ventilation and Air Conditioning) of a commercially available vehicle, and the electrical conduction heating test was subjected to the heater unit at a gas flow rate of 6 m/sec while limiting a current to 30 A or less under a constant voltage control of 250 V.

As a result, the gas temperature at the outlet of the HVAC reached 60° C. in 8 seconds after the electrical conduction heating, and increased to 100° C. after 60 seconds. The electric power at this time was 3.4 kW. Also, the energy consumption after 30 seconds of the start of electrical conduction was 108 kJ.

### Comparative Example 1

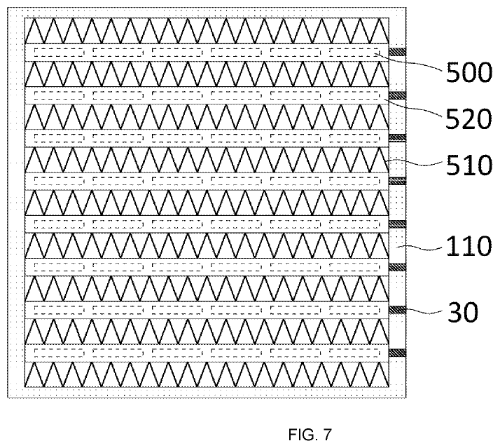

A conventional heater unit was prepared in which heater elements having PTC elements 500 integrated with aluminum fins 510 were stacked and arranged, as shown in FIG. 7. It should be noted that FIG. 7 is a schematic plane view of the heater element.

Each PTC element 500 had a size of 29 mm×8 mm×2 mm, and housed inside a heater body 520 while arranging six elements in a row and combining them with members such as a frame, insulating plates, and conductive plates. Also, the heater body 520 was provided with the connectors 30. Further, the eight heater bodies 520 were housed in the housing 110 and configured such that each aluminum fin 510 was arranged between the heater bodies 520.

Each PTC element 500 was made of a material containing 49 mol % of TiO₂, 32 mol % of BaO, 9 mol % of PbO, 8 mol % of CaO, 1 mol % of SrO and 1 mol % of SiO₂.

The above conventional heater unit was incorporated into HVA of a commercially available vehicle, and the electrical conduction heating test was subjected to the heater unit at a gas flow rate of 6 m/sec while limiting a current to 30 A or less under a constant voltage control of 3000 V.

As a result, the gas temperature at the outlet of the HVAC reached 50° C. in 11 seconds after the electrical conduction heating, and increased to 88° C. after 60 seconds. The electric power at this time was 2.8 kW. Also, the energy consumption after 30 seconds of the start of electrical conduction was 123 kJ.

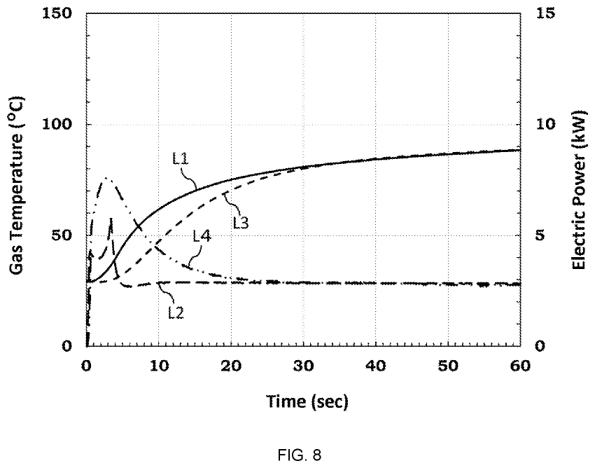

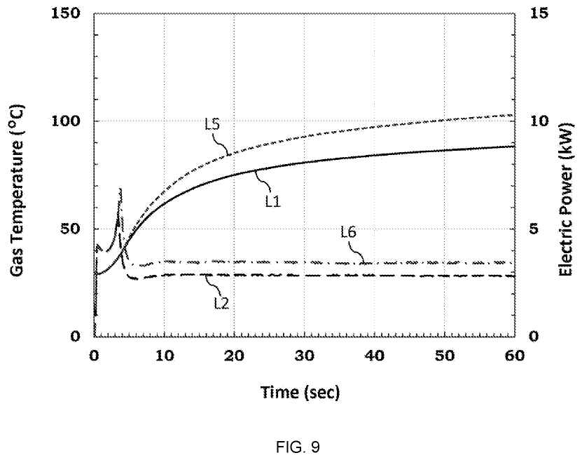

Here, FIG. 8 shows a graph comparing the results of the electrical conduction tests according to Example 1 and Comparative Example 1. Further, FIG. 9 shows a graph comparing the results of the electrical conduction tests according to Examples 1 and 2. In FIGS. 8 and 9, L1 represents the gas temperature at the outlet for Example 1, L2 represents the electric power for Example 1, L3 represents the gas temperature at the outlet for Comparative Example 1, L4 represents the electric power for Comparative Example 1, L5 represents the gas temperature at the outlet for Example 2, and L6 represent the electric power for Example 2.

As shown in FIG. 8, the heater unit according to Example 1 could shorten the heating time of the gas temperature as compared to the heater unit according to Comparative Example 1 (comparison of L1 to L3). For example, the time from the start of the electrical conduction to the gas temperature of 50° C. was 6 seconds for Example 1, whereas it was 11 seconds for Comparative Example 1, indicating that the former could shorten the heating time of the gas temperature by 40%. Also, the heater unit according to Example 1 could reduce the maximum electric power during the electrical conduction as compared to the heater unit according to Comparative Example 1 (comparison of L2 with L4). For example, the maximum electric power during the electrical conduction was 5.8 kW for Example 1, whereas it was 7.6 kW for Comparative Example 1, indicating that the maximum power could be reduced by 25%.

As shown in FIG. 9, the heater unit according Example 2 could further shorten the heating time of the gas temperature as compared to the heater unit according to Example 1, and the temperature of the gas after 60 seconds was higher (comparison of L1 to L5). On the other hand, the maximum power during the electrical conduction was lower for the heater unit according to Example 1 than for the heater unit according to Example 2 (comparison L2 to L6).

As can be seen from the above results, according to the present invention, it is possible to provide a heater element for heating a vehicle interior, which has a simpler structure than that of the existing heater element, and which can suppress an increase in the size of the unit due to design changes of parts such as wirings and holders of the existing heater unit. Also, according to the present invention, it is possible to provide a heater unit for heating a vehicle interior and a heater system for heating a vehicle interior, which use the heater element for heating the vehicle interior.

### DESCRIPTION OF REFERENCE NUMERALS

10 honeycomb structure
11 outer peripheral wall
12 partition wall
13a first end face
13b second end face
14 cell
15 short side
16 long side
17 honeycomb joined body
18 honeycomb segment
19 joining layer
20 electrode
30 connector
100 heater element
110 housing
120 insulating material
200 heater unit
300 heater system
301 inflow port
302 outflow port
310 vehicle interior
320a, 320b inflow pipe
325 outflow pipe
330 battery
340 electric wire
350 vapor compression heat pump
351 evaporator
352 condenser
360 blower
500 PTC element
510 aluminum fin
520 heater body

1. A heater element for heating a vehicle interior, comprising:
a honeycomb structure comprising: an outer peripheral wall; and a partition wall disposed on an inner side of the outer peripheral wall, the partition wall defining a plurality of cells each forming a flow path from a first end face to a second end face, the outer peripheral wall and the partition wall comprising a material having a PTC property; and
a pair of electrodes provided on the first end face and the second end face,
wherein each of the first end face and the second end face of the honeycomb structure is rectangular, and
wherein the heater element for heating the vehicle interior further comprises a pair of connectors, each of the connectors being connected to the electrode from one short side of each of the first end face and the second end face.

2. The heater element for heating the vehicle interior according to claim 1, wherein the first end face and the second end face have a ratio of a length of the short side to a length of the long side of from 1:2 to 1:10.

3. The heater element for heating the vehicle interior according to claim 1, wherein the honeycomb structure is a honeycomb joined body having a plurality of honeycomb segments and joining layers for joining the plurality of honeycomb segments to each other.

4. The heater element for heating the vehicle interior according to claim 1, wherein the pair of electrodes have extending portions each extending outwardly in the same direction from one short side of each of the first end face and the second end face, and the extending portions and the connectors are connected to each other.

5. The heater element for heating the vehicle interior according to claim 1, wherein the honeycomb structure has a thickness of the partition wall of 0.125 mm or less, a cell density of 93 cells/cm² or less, and a cell pitch of 1.0 mm or more.

6. The heater element for heating the vehicle interior according to claim 1, wherein the outer peripheral wall and the partition wall are made of a material that contains barium titanate as a main component and is substantially free of lead.

7. The heater element for heating the vehicle interior according to claim 1, wherein the pair of electrodes comprise: electrode layers provided on the first end face and the second end face; and electrode plates provided on the electrode layers.

8. The heater element for heating the vehicle interior according to claim 7, wherein the electrode plates have extending portions each extending outwardly in the same direction from one short side of each of the first end face and the second end face, and the extending portions are connected to the connectors.

9. A heater unit for heating a vehicle interior, comprising two or more of the heater elements for heating the vehicle interior according to claim 1,
wherein the heater elements for heating the vehicle interior are stacked and arranged such that surfaces of the outer peripheral walls of the honeycomb structures, including long sides of the first end faces and the second end faces, are opposed to each other.

10. The heater unit for heating the vehicle interior according to claim 9, wherein insulating materials are arranged between the heater elements for heating the vehicle interior stacked and arranged.

11. A heater system for heating a vehicle interior, comprising:
the heater unit for heating the vehicle interior according to claim 9;
an inflow pipe for communicating an outside air introduction portion or a vehicle interior with an inflow port of the heater unit for heating the vehicle interior;
a battery for applying a voltage to the heater unit for heating the vehicle interior; and
an outflow pipe for communicating an outflow port of the heater unit for heating the vehicle interior with the vehicle interior.
